(19) United States
(12) Patent Application Publication
(10) Pub. No.: US 2003/0070513 A1
(43) Pub. Date: Apr. 17, 2003

(54) Combined hexagonal wrench

(76) Inventor: Yi-Chuan Hsu, Miaoli City (TW)

Correspondence Address: BRUCE H. TROXELL, SUITE 1404, 5205 LEESBURG PIKE, FALLS CHURCH, VA, 22041, US

(21) Appl. No.: 10/076,549

(22) Filed: Feb. 19, 2002

(30) Foreign Application Priority Data
Oct. 12, 2001 (TW) 90217589

(51) Int. Cl. B25B 23/00

(52) U.S. Cl. 81/439

(57) ABSTRACT

A combined hexagonal wrench has a main body, which has a body segment, an inner engaging segment at one end of the body segment, and a stopping segment. A sidable engaging device slidable mounts on the main body. The slidable engaging device has a tube segment, an outer engaging segment at one end of the tube segment, and a stopping segment for interfering with the stopping segment of the main body to prevent the slidable engaging device escaping from the main body. An elastic device receives in the space between the slidable engaging device and the main body for keeping the slidable engaging device in an initial position of the slidable engaging device covering the inner engaging segment of the main body.

### FIELD OF THE INVENTION

The present invention relates generally to a hand tool, and more particularly to a combined hexagonal wrench with multi dimensions.

### BACKGROUND OF THE INVENTION

The conventional hexagonal wrenches are made into L-shaped or I-shaped. The L-shaped hexagonal wrench is made by drawing a metal into a shaft and bending it into L-shaped. The I-shaped usually provides a holding segment for facilitating user to grip.

For user has to turn the different dimensions of bolts in normal work, it needs a plurality of hexagonal wrenches of different dimensions. For the point of view, the hexagonal wrenches are different to restore or to carry. The combined hexagonal wrench or the box for restoring the hexagonal wrenches is provided to solve the problem described above.

The solutions for the conventional hexagonal wrench surely have the advantage of easy to carry and restore. But the hexagonal wrenches still are made of metal. As we know, the larger dimension hexagonal wrench has a larger weight, and it needs more metal to manufacture. However, there is only less than 1 cm from the end of the hexagonal wrench is needed to engage to the bolt. The rest part of the hexagonal wrench gives no help in turning the bolt. In the larger dimension hexagonal wrench, the useless part will take a larger proportion of the hexagonal wrench.

Beside that, there usually are two or three dimensions of the hexagonal wrenches will be used in a normal work. Some of the hexagonal wrenches are hardly used in a specific work.

### SUMMARY OF THE INVENTION

The primary objective of the invention is to provide a combined hexagonal wrench, which has the advantages of less material to manufacture, less weight, easy to carry, easy to operate, and has a longer product life.

According to the objective of the invention, the combined hexagonal wrench has a main body, which has a body segment, an inner engaging segment at one end of the body segment, and a stopping segment. A slidable engaging device slidable mounts on the main body. The slidable engaging device has a tube segment, an outer engaging segment at one end of the tube segment, and a stopping segment for interfering with the stopping segment of the main body to prevent the slidable engaging device escaping from the main body. An elastic device receives in the space between the slidable engaging device and the main body for keeping the slidable engaging device in an initial position of the slidable engaging device covering the inner engaging segment of the main body when not used.

### BRIEF DESCRIPTION OF THE DRAWINGS

FIG. 1 is a sketch view of a first prefer embodiment of the present invention;

FIG. 2 is a sectional view in part of the first prefer embodiment of the present invention;

FIG. 3 and FIG. 4 are sketch views of the first prefer embodiment of the present invention in operating;

FIG. 5 is a sketch view of a second prefer embodiment of the present invention, which provides a L-shaped hexagonal wrench;

FIG. 6 and FIG. 7 are sketch views of the second prefer embodiment of the present invention, which provides two types of Y-shaped hexagonal wrench;

FIG. 8 is an exploded view of a third prefer embodiment of the present invention, and

FIG. 9 is a sketch view of a fourth prefer embodiment of the present invention.

### DETAIL DESCRIPTION OF THE INVENTION

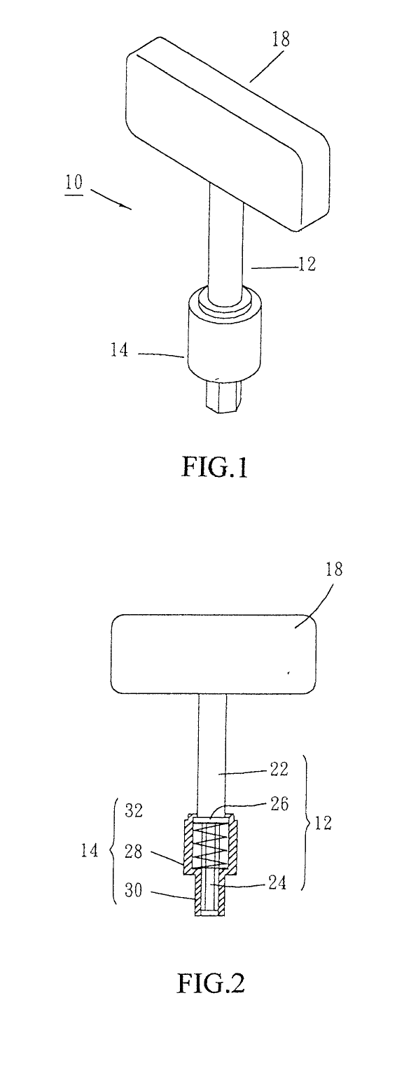

Please refer to FIG. 1 and FIG. 2, the first prefer embodiment of the present invention provides a combined hexagonal wrench 10, which have a main body 12. The main body 12 is made of metal in the present embodiment. In practice, the main body 12 can be made of any type of rigid material. The main body 12 has a body segment 22 and an inner engaging segment 24 with one end thereof connecting to the body segment 22. The cross-section of the inner engaging segment 24 is hexagon for engaging to a bolt to drive it to turn. The length of the inner engaging segment 24 is set to in the range of 0.4 cm to 1.0 cm. A stopping portion 26 is provided at the proximal end of the inner engaging segment 24.

A slidable engaging device 14 is made of rigid material and has a length larger than the inner engaging segment 24. The slidable engaging device 14 is tube-shaped, which has a tube segment 28 and an outer engaging segment 30. The inner diameter of the tube segment 28 is larger than the outer diameter of the body segment 22. And the inner diameter of the outer engaging segment 30 is smaller than the outer diameter of the body segment 22, but slightly larger than inner engaging segment 24. The tube segment 28 has a stopping segment 32 at the opposite end from the outer engaging segment 30. In practice, the stopping segment 32 can be made by bending the end of the tube segment 28 inwards to narrow the inner diameter of the tube segment 32.

The inner engaging segment 24 of the main body 12 receives in the slidable engaging device 14 with the inner engaging segment 24 and the outer engaging segment 30 orientating to the same direction. Thus, the slidable engaging device 14 can slide along the main body 12 and the topping potion 32 of the slidable engaging device 14 will interfere with the topping potion 26 of the main body 12 to prevent the slidable engaging device 14 escaping from the main body 12.

It has to mention here, the diameters of the inner engaging segment 24 and the outer engaging segment 30 can choose from two dimensions of bolts, which we most frequently meet in a normal work.

An elastic device 16, which is a spring in the present embodiment, receives in the space between the inner engaging segment 24 and the tube segment 28. The elastic device 16 has one end thereof being against the tube segment 28 and the other end being against the stopping segment 26 of the main body 12, such that the initial position of the slidable engaging device 14 is kept at the inner engaging segment 24 receiving inside of the outer engaging segment 30 and the edges of the distal end of the inner engaging segment 24 and the distal end of the outer engaging segment 30 are locating at same level.

The combined hexagonal wrench 10 of the first embodiment of the present invention further has a holding segment 18 for facilitating user to grip it to turn the combined hexagonal wrench 10.

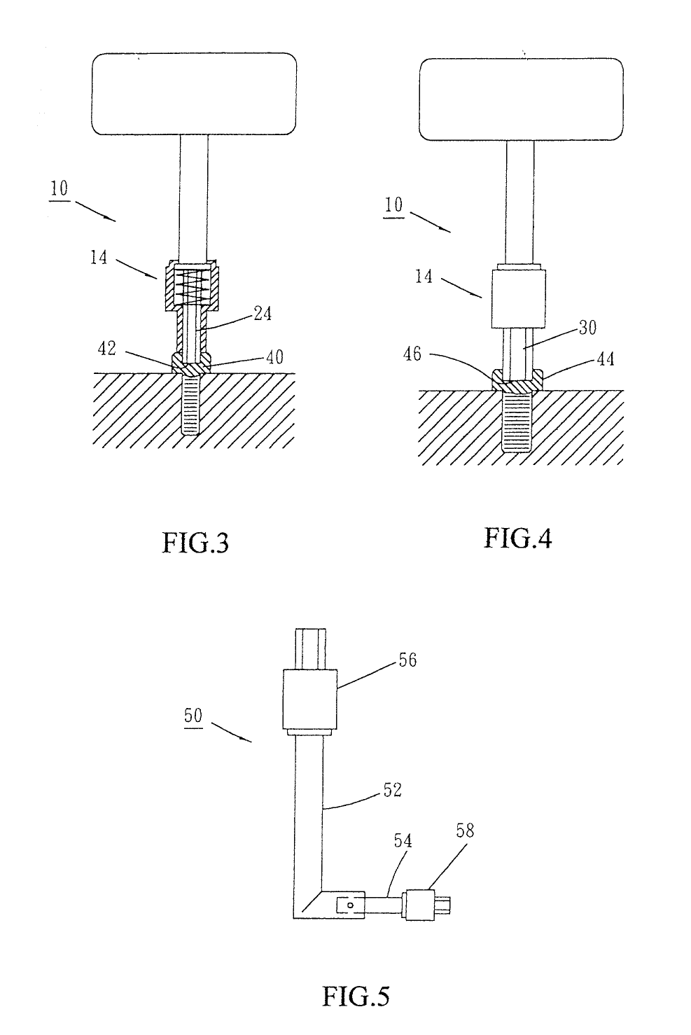

In operating, please refer to FIG. 3, if we trying to turn a smaller bolt 40 having a dimension corresponding to the inner engaging segment 24 of the main body 12. The slidable engaging device 14 will be pushed inwards by the bolt 40 and let the inner engaging segment 24 going out of the slidable engaging device 14 to engage to the engaging slot 42 of the bolt 40. Thus, user can turn the combined hexagonal wrench 10 of the present invention to drive the smaller bolt 40 to turn tight or to turn loose.

If there is a larger bolt 44 having a dimension corresponding to the outer engaging segment 40 of the sidable engaging device 14. Please refer to FIG. 4, the outer engaging segment 30 of the slidable engaging device 14 will engage to the engaging slot 46 of the bolt 44 directly. Thus, the combined hexagonal wrench 10 of the present invention can drive the larger bolt 46 to turn tight or to turn loose.

We can provide another function of the combined hexagonal wrench 10 of the present invention to turn a nut. If we provide the edge of the inner engaging segment 24 receiving in the outer engaging segment 40, which means there will be a hexagonal space (not shown in FIG.) remained in the outer engaging segment 40 from the end thereof to the end of the inner engaging segment 24. Thus, the outer engaging segment 40 can work like a socket wrench to receive a nut therein to drive it to turn.

As the discussion we have described in background, there is less than 1 cm of the combined hexagonal wrench is to engage to the bolt. We provide the tube-shaped slidable engaging device 14, which has a smaller length and has the outer engaging segment 30 of larger diameter covering at the outside of the main body 12. Thus, the combined hexagonal wrench 10 of the present invention can turn a larger bolt or to can turn a smaller bolt with the same tool. For the most, the combined hexagonal wrench 10 of the present invention has a smaller size for facilitating to carry and less cost for manufacture.

Now please refer to FIG. 5, which shows a combined hexagonal wrench 50 of the second prefer embodiment of the present invention. The combined hexagonal wrench 50 has two main bodies 52 and 54 and two slidable engaging devices 56 and 58. The elements of the combined hexagonal wrench 50 of the second prefer embodiment have a same structure as the corresponding elements of the first embodiment. One of the main bodies 52 is made into a substantial L-shaped. The other the main body 54 is pivoting to the main body 52 whereby the main body 54 can adjust the angel. We just make the combined hexagonal wrench 50 of the second prefer embodiment into L-shaped and can turn four different dimensions bolts with one tool.

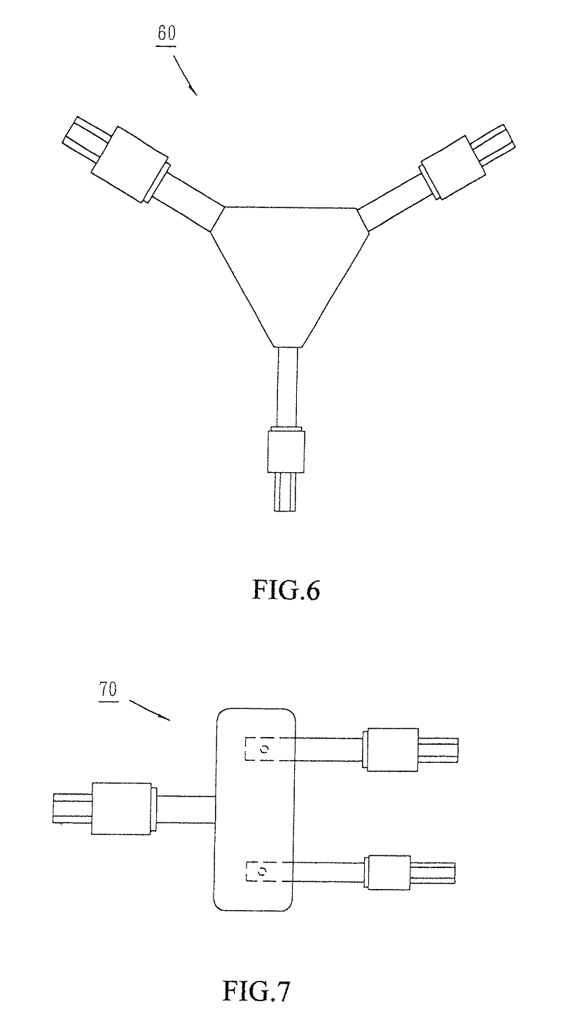

For the same principle, two Y-shaped combined hexagonal wrenches 60 and 70 are shown in FIG. 6 and FIG. 7. They provide the function of more bolts with different dimensions can be turn with one tool. It has to mention, the Y-shaped combined hexagonal wrench 70 provides two of the main bodies pivoting to the third main body to adjust the tool angel.

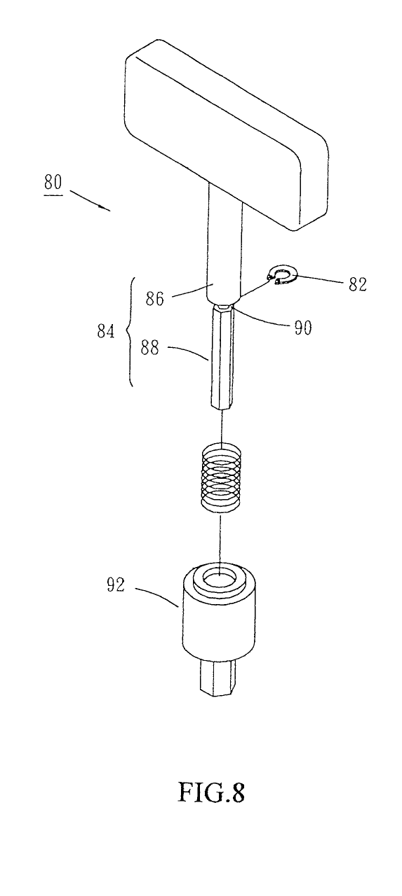

Please refer to FIG. 8, the third prefer embodiment of the present invention provides a combined hexagonal wrench 80, which mainly has a same structure as the combined hexagonal wrench 10 of the first prefer embodiment. Except that, the combined hexagonal wrench 80 of the third prefer embodiment provides a stopping segment 82, which is a C-shaped ring, mounting on a ring slot 90 of a main body 82. The stopping segment 82 of the third prefer embodiment has the same function as the stopping segment 26 of the first prefer embodiment.

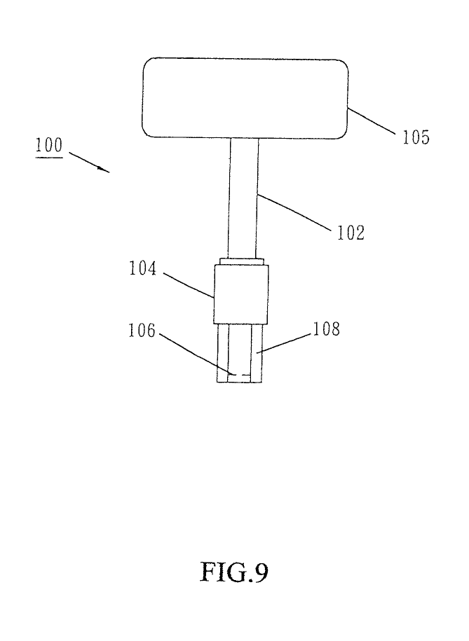

FIG. 9 shows a combined hexagonal wrench 100 of the fourth prefer embodiment of the present invention, similar to the hexagonal wrench 100 as described in the first prefer embodiment, comprising a main body 102, a slidable engaging device 104 and a holding segment 105. The hexagonal wrench 100 of the fourth prefer embodiment further provides a socket 108 on the engaging segment 106 of the slidable engaging device 104. The socket 108 has a hexagonal opening at an end thereof and has a shape corresponding to the engaging segment 106 of the slidable engaging device 104. The socket 108 engages to the engaging segment 106 under locational interference fit, for it may be disassembled. The socket 108 has a larger dimension than the engaging segment 106 for turning a larger bolt.

Another advantage of the present invention we had to mention here is that the slidable engaging device covers the elastic device can prevent the dust or the same interfering the elastic device working. That will make the slidable engaging device can operating correctly after a long time use.

What is claimed is:

1. A combined hexagonal wrench comprising:
a main body having a body segment, an inner engaging segment at an end of said body segment, and a stopping segment;
a slidable engaging device slidable disposed on said main body; said slidable engaging device having a tube segment, an outer engaging segment at an end of said tube segment, and a stopping segment at the other end of said tube segment for interfering with said stopping segment of said main body to prevent said slidable engaging device escaping from said main body; said outer engaging segment corresponding to said inner engaging segment of said main body, and
an elastic device received in the space between said main body and said slidable engaging device with two opposite ends thereof being against said slidable engaging device and said main body respectively to provide said slidable engaging device an initial position of covering said inner engaging segment of said main body.

2. The combined hexagonal wrench as defined in claim 1, wherein the length of said slidable engaging device is larger than the length of said inner engaging segment of said main body.

3. The combined hexagonal wrench as defined in claim 1, wherein said elastic device is a spring.

4. The combined hexagonal wrench as defined in claim 3, wherein said elastic device is received in said tube segment of said slidable engaging device.

5. The combined hexagonal wrench as defined in claim 1, wherein the cross-sections of said slidable engaging device and said inner engaging segment are polyhedrons.

6. The combined hexagonal wrench as defined in claim 1, wherein said main body further comprises a holding segment at the end of opposite from said inner engaging segment.

7. The combined hexagonal wrench as defined in claim 1, wherein has three of said main bodies and three of said slidable engaging devices, and said body segments of said main bodies respectively have ends thereof connecting to each other to form a Y-shaped hexagonal wrench.

8. The combined hexagonal wrench as defined in claim 7, wherein said body segments of said main bodies have ends thereof pivoting with each other.

9. The combined hexagonal wrench as defined in claim 7, wherein said outer engaging segments of said slidable engaging devices and said inner engaging segments of said main bodies have different outer diameters.

10. The combined hexagonal wrench as defined in claim 1, wherein has two said main bodies and two said slidable engaging devices, and said body segments of said main bodies have ends thereof connecting to each other to form a L-shaped hexagonal wrench.

11. The combined hexagonal wrench as defined in claim 10, wherein said body segments of said main bodies have ends thereof pivoting with each other.

12. The combined hexagonal wrench as defined in claim 10, wherein said outer engaging segments of said slidable engaging devices and said inner engaging segments of said main bodies have different outer diameters.

13. The combined hexagonal wrench as defined in claim 1, wherein said stopping segment of said main body is a C-shaped ring mounting on said body segment.

14. The combined hexagonal wrench as defined in claim 1, wherein the edges of the distal end of said inner engaging segment and the distal end of said outer engaging segment are located at a same level.

15. The combined hexagonal wrench as defined in claim 1, wherein the distal end of said inner engaging segment is received in said outer engaging segment.

16. The combined hexagonal wrench as defined in claim 1, wherein further comprises a socket provided on the engaging segment of the slidable engaging device.
